(19) United States
(12) Patent Application Publication
(10) Pub. No.: US 2013/0346235 A1
(43) Pub. Date: Dec. 26, 2013

(54) Systems, Methods, and Computer Program Products for Caching of Shopping Items

(71) Applicant: LiMin Lam, San Francisco, CA (US)

(72) Inventor: LiMin Lam, San Francisco, CA (US)

(73) Assignee: eBay, Inc., San Jose, CA (US)

(21) Appl. No.: 13/528,604

(22) Filed: Jun. 20, 2012

(51) Int. Cl. G06Q 30/00

(52) U.S. Cl. 705/26.8

(57) ABSTRACT

An electronic system including an input/output interface operable to receive an input from a user and communicate an output to the user, a transceiver operable to electronically communicate with a computer network, a computer processor operable to execute instructions, and a memory storage operable to store the instructions, the memory storage further comprising a program module that is operable to: receive identifying information of a physical shopping item while at a physical shopping location selling the physical shopping item, the identifying information including at least an identifier of the physical shopping location and a visual depiction of the physical shopping item, cache the identifying information in a shopping list with a plurality of other physical shopping items, and provide access to the shopping list for a user at a later time.

### BACKGROUND

1. Technical Field

The present disclosure generally relates to identifying shopping items, and more particularly, to techniques for saving identified shopping items for later viewing.

2. Related Art

Recent advances in the fields of telecommunications and integrated circuits have drastically increased the popularity of portable electronic telecommunication devices. As some non-limiting examples, these portable telecommunication devices may include smart phones, computer tablets, or laptops. Users of these devices may use them to perform a variety of tasks. For example, many smart phones and computer tablets can be used to scan a product at a store and extract information about such product. The extracted information may include the description of the product, names of other retailers (either online or physical) carrying the product, prices of the product at the other retailers, and other suitable information. Examples of applications that provide such functionality to wireless devices include, e.g., an application by eBay Inc. and an application by Amazon.com, Inc. Another application from Shopstyle™ by Sugar Inc. allows a user to shop online, identify items of interest, and then receive sale updates when an item goes on sale by an online vendor.

Other wireless applications allow users to take pictures of physical items and then to use those pictures to find similar items. An example is the eBay Image Swatch™ application that allows a user to take a picture of an item and to find similar items of the same color. Another application includes one from Google, Inc. that allows a user to take a picture of an item and to fit the item to a dress form; the application then checks online for clothes fitting the form and the color.

These capabilities of the portable telecommunication devices have not, however, been fully utilized to create a better shopping experience for their users who may be shopping at a brick and mortar store or online.

Furthermore, physical shopping at brick and mortar stores has some advantages over online shopping. For instance, some brick and mortar stores are located in interesting places and/or specialize in one-of-a-kind goods, thereby inviting foot traffic into the store. Also, some brick and mortar stores allow shoppers to try out goods before purchasing, which is usually not possible with online shopping. In some scenarios, a person may encounter a physical item offered by a brick and mortar merchant but at a time when it is not possible or convenient to make the purchase. But unlike online shopping, it may take more effort or time for the person to return to the item later, and the person may forget about the item before returning. A system and method to bridge the online and brick and mortar worlds would be desirable.

### SUMMARY

One of the broader forms of the present disclosure involves an electronic system including an input/output interface operable to receive an input from a user and communicate an output to the user, a transceiver operable to electronically communicate with a computer network, a computer processor operable to execute instructions, and a memory storage operable to store the instructions, the memory storage further comprising a program module that is operable to: receive identifying information of a physical shopping item while at a physical shopping location selling the physical shopping item, the identifying information including at least an identifier of the physical shopping location and a visual depiction of the physical shopping item, cache the identifying information in a shopping list with a plurality of other physical shopping items, and provide access to the shopping list for a user at a later time.

Another one of the broader forms of the present disclosure involves a method including receiving an identification of a physical shopping item from a user at a physical store, the identification including at least a visual representation of the physical shopping item and an identifier of the physical store, entering the identifying information into a personal shopping list corresponding to the user, where the shopping list is accessible at a later time of the user's choosing, searching for the physical shopping item at other retailers, and sending a price update to the user regarding the physical shopping item.

Another one of the broader forms of the present disclosure involves a computer program product having a computer readable medium tangibly recording computer program logic for facilitating shopping, the computer program product including code to receive input from a user at a mobile device, the input identifying a physical shopping item at a physical store at which the user is located, code to enter a description of the physical shopping item, including a visual depiction of the physical shopping item and an identifier of the physical store into a personal shopping list for the user, where the personal shopping list is available to the user at a later time of the user's choosing, and code to search online for the physical shopping item and to return results of the search to the user, and code to provide price updates for the physical shopping item to the user.

### BRIEF DESCRIPTION OF THE DRAWINGS

FIGS. 1-5 illustrate example user interfaces of an example application program according to various aspects of the present disclosure.

FIG. 6 illustrates a flowchart containing example process flows according to various aspects of the present disclosure.

FIG. 7 illustrates an example computer system, including a network, on which users and merchants interact with each other and with cloud-based resources.

FIG. 8 illustrates a block diagram of a computer system for implementing various methods and devices described according to various aspects of the present disclosure.

FIG. 9 illustrates a block diagram of a computer system for implementing various methods and devices described according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

According to the various aspects of the present disclosure, a method, system, and computer program product are discussed below that add online shopping convenience to brick and mortar shopping.

It is easy for a consumer to like new things as she sees them, but often harder to justify buying them on the spot. Unless an item is on sale or if the consumer realizes there and then that it is more than just a spontaneous purchase the consumer might just tell herself that the purchase is not practical and pass. Various embodiments described in more detail below enable consumers to use a mobile application (or “app”) to create a wishlist as they shop at physical brick and mortar stores and to keep those almost-made purchases in mind.

Whether the consumer is at an electronics store, an auto-dealership, or a clothing store, the consumer can use the app to document items that she might want to buy at a later date. The app can identify physical shopping items in any appropriate manner, such as by scanning a Quick Response (QR) code or image matching a digital picture with other visual images. The app documents the item details as well as the price of the item at that particular store/location. This information is then compiled with other items in the wishlist. Periodically or at other specified times, the app automatically (1) searches for the same item at other online/local retailers to find competitive prices, and (2) automatically alerts the user if the same item goes on sale at a later date. Also, the app provides the consumer with a way to be reminded later, at a more convenient time, of the various items on a wishlist or personal shopping list. The consumer may buy the item online from a merchant indicated by the app or may stop by the physical store to buy the item.

In a further example, the app sends the information to an online program that is also accessed by a number of merchants. When a consumer adds an item to her wishlist from a participating store, the merchant at the store receives a notification. In this manner, the merchant is informed of interest in the merchant's goods, and the merchant may adjust a price of the item in order to trigger the consumer to buy the item. Furthermore, the merchant may send messages to the consumer and/or may offer an option to buy the item online through the app.

Such features may allow a brick and mortar retailer to compete with online retailers by being in front of consumers and knowing when someone is interested in making purchases. Such features may also benefit consumers by allowing consumers to compare physical shopping items and receive updates on physical shopping items in a manner similar to online shopping.

In one example use case, a consumer is running errands and walks by a new item in a storefront. The consumer is interested in the item, but she is not in the mindset to buy the item at that particular time because she is either focused on running her errands, does not want to make the purchase without more research, or does not want to pay full price for the item.

The consumer then opens this wishlist mobile app on a mobile device, such as a smartphone, and uses a QR code scanner or image match to log the item image, item details as well as the price of the item at that date in that particular store/location.

The app itself or online computer resources adds the item to her ongoing wishlist of items, and the app or other resources automatically search and display the same item at other online/local retailers to find competitive prices.

The consumer moves on with her errands and a week later receives an automatic alert from the app that the same item went on sale at a later date at the same merchant or a different merchant. The person is reminded of the item by the alert, likes the price that she sees and goes back to the store to try/test the item before making the purchase at the store or online.

Of course, the scope of embodiments is not limited to the examples above. For instance, some embodiments also allow the user to identify products found online as well.

Various embodiments include, among other things, methods in accordance with the description above, as well as computer systems for performing the method. The examples below provide a detailed illustration of several example embodiments.

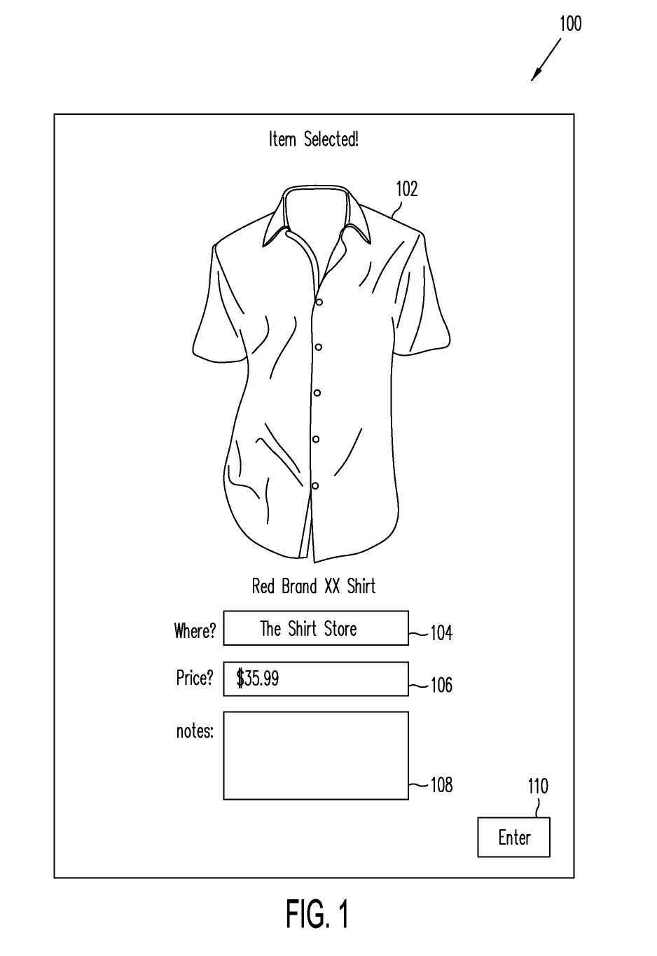

FIG. 1 illustrates an example user interface 100 for a portable electronic device adapted according to one embodiment. In the illustrated embodiment, the portable electronic device is a smart phone. In alternative embodiments, the portable electronic device may be another suitable electronic device such as a computer tablet or a laptop. A user may download application software programs, also known as “apps” or “applications” to the portable electronic device. In general, applications are computer software programs designed to execute specific tasks. As examples, both Apple's® App Store and Google's Android Market offer a multitude of applications, including entertainment programs, business programs, file management tools, and other widgets, etc.

Interface 100 is an example of an interface seen by a user when identifying a physical item while at a physical store. Interface 100 may be embodied in any appropriate manner, such as on a touch screen interface or another Graphical User Interface (GUI) that uses a mouse or other pointing device.

FIG. 1 starts off after the consumer has already selected an item. In this example, the consumer has identified a red shirt, which is shown in thumbnail image 102. Identifying a physical shopping item (such as a shirt) may be accomplished in any appropriate manner. In one example, the consumer uses the mobile device to take a digital photograph of the item. The app, and/or other computing resources online, may then use image recognition to compare the photograph to other items online and then to provide several possible matches from which the consumer may choose a correct item. For instance, if the red shirt is of a particular style and from a particular brand, the image matching functionality may attempt to find the particular shirt from online catalogs or other resources.

In some instances, the shirt may not be cataloged online, such as, e.g., if the shirt is only available in-store or is unique/custom made. In such instances, the actual photograph taken by the consumer may be best visual representation available. In any event, a representation of the shirt is shown as thumbnail 102.

In another example, the consumer identifies the shirt by scanning a code that is associated with the item. For instance, the app may include functionality to read a QR code, bar code, or other visual code and to check an online database for information on the shirt. In many instances, such codes are placed on tags attached to items, on racks, on store shelves, and the like and may be photographed with a camera on a mobile device. The app may then return one or more potential matches to the consumer from which the consumer may pick the most accurate one. Although it is generally difficult to identify clothing by comparing captured visual information and comparing it to catalog data, the same idea can easily be applied to any appropriate item for sale. For example, books, Digital Video Disks (DVDs), and electronics are examples of items that tend have more structured catalog data and may be more easy to search for online. The concepts described herein are not limited to apparel and fashion, as the concepts extend to any appropriate merchandise or service.

Interface 100 in FIG. 1 is shown with information fields 104, 106, 108. Furthermore, the information identifying the type of physical shopping item (“red Brand XX shirt”) is already filled in. Various embodiments may automatically populate or manually populate any of the fields 104, 106, 108, as appropriate. For instance, in a scenario wherein an item is easily matched to an online catalog (e.g., by scanning a QR code), the type of product may be populated automatically (as in this example).

Some embodiments include other functionality to populate other fields as well. For instance, many mobile devices include location determining technology, such as Global Positioning System (GPS) technology, assisted GPS, and/or the like. An app running on a mobile device may use location determining technology to determine the location within a range of error (e.g., within 300 yards) and then present the consumer with a list of possibilities to fill in field 104. Additionally, the app running on the mobile device may access the location information by scanning a QR code or other code and then being directed to a database with information that includes the location information. Of course, the consumer can also fill in field 104 manually. Field 104 may include name information, such as the name of the physical store, address information, latitude and longitude, and/or the like.

Field 106 holds price information. In some instances wherein the merchant at the physical store has an online database, the app on the mobile device may populate field 106 automatically. For instance, when the consumer scans a QR code, the app may be directed to a database that includes specific information for the item, including price. In other instances, it may be up to the consumer to fill in price herself.

Field 108 is for notes. A consumer may wish to add information in field 108 to assist in remembering a characteristic of the item or store later. An example includes, “looks good, but may be better in black” or other such personal notes.

Enter button 110 allows the user to finalize the entry in the list. Upon entry, the app on the mobile device caches the information about the item. The app may cache the information locally on the mobile device, online at a cloud resource, or in any other appropriate manner. Furthermore, the app may save more than just the information shown in the fields 104, 106, 108 of FIG. 1. Other data, such as the consumer's frequented stores, consumer's clothing sizes, and the like may be cached as well, with or without the consumer's knowledge.

The scope of embodiments is not limited to the information shown in FIG. 1, as any other appropriate item of information may be entered and/or cached in various embodiments. For instance, more detailed product information, such as size, compatibility with other items, fabric/material, style, occasion, season, care instructions, pattern, color, manufacture location, etc. may be entered and cached as well. Items other than fashion/apparel may have different detailed product information.

FIG. 1 is an illustration of example interface 100, where interface 100 is shown as it would be rendered on a screen of a mobile device. Interface 100 can be configured in any appropriate manner, such as in a touch screen configuration, a configuration for use with a cursor-pointing device, or any other interface configuration now known or later developed.

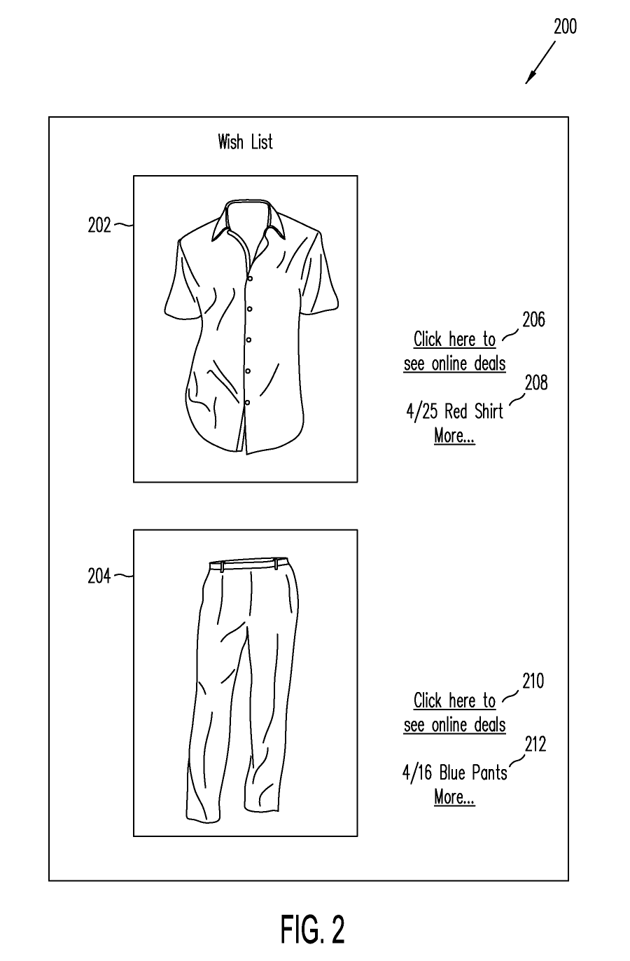

FIG. 2 is an illustration of example interface 200 for viewing the consumer's wishlist, according to one embodiment. In the present example, the consumer has entered information about the red shirt (from FIG. 1), and the app has cached the information. The app, or other computing resource, aggregates the information about the shirt with information of other physical shopping items to create an aggregated wishlist for the consumer. In this example, the consumer has also shown interest in a pair of blue pants, as shown in FIG. 1.

Interface 200 includes thumbnails 202, 204 to show a brief visual representation of physical shopping items in the wishlist. Interface 200 also includes links 208, 212, which allow the consumer to view the respective items in more detail on another screen (not shown). Interface 200 further includes links 206, 210, which bring the consumer to a screen (also not shown) that shows online offerings of similar products to allow the consumer to compare price and availability at a number of merchants. Interface 200 also includes a respective date for each item, thereby reminding the consumer about the timeframe in which the consumer saw the items.

In some embodiments, the consumer may choose to buy an item from the wishlist online while viewing the wishlist. For instance, the consumer may use links 206 and 210 to view online listing and then to use one or more of the online listings for purchasing the item from the same, or a different, merchant.

It is understood that the items in interface 200 are for example only, and in various embodiments a wishlist interface may include any appropriate number of entries and any appropriate links to other materials. In some embodiments, the app may delete items from the wishlist after a specified time or in response to user input to keep the size of the wishlist manageable. In fact, any appropriate technique for regulating or not regulating the number of items in the wishlist interface 200 is within the scope of embodiments. In various embodiments, a given wishlist can have any appropriate number of entries of any appropriate age.

In this example, the information is cached by the app so that the consumer may return to the information at a more convenient time. Thus, the consumer may enter several items into the wishlist over the course of a week or so and then access the wishlist interface 200 at a convenient opportunity, such as on the weekend or at lunch.

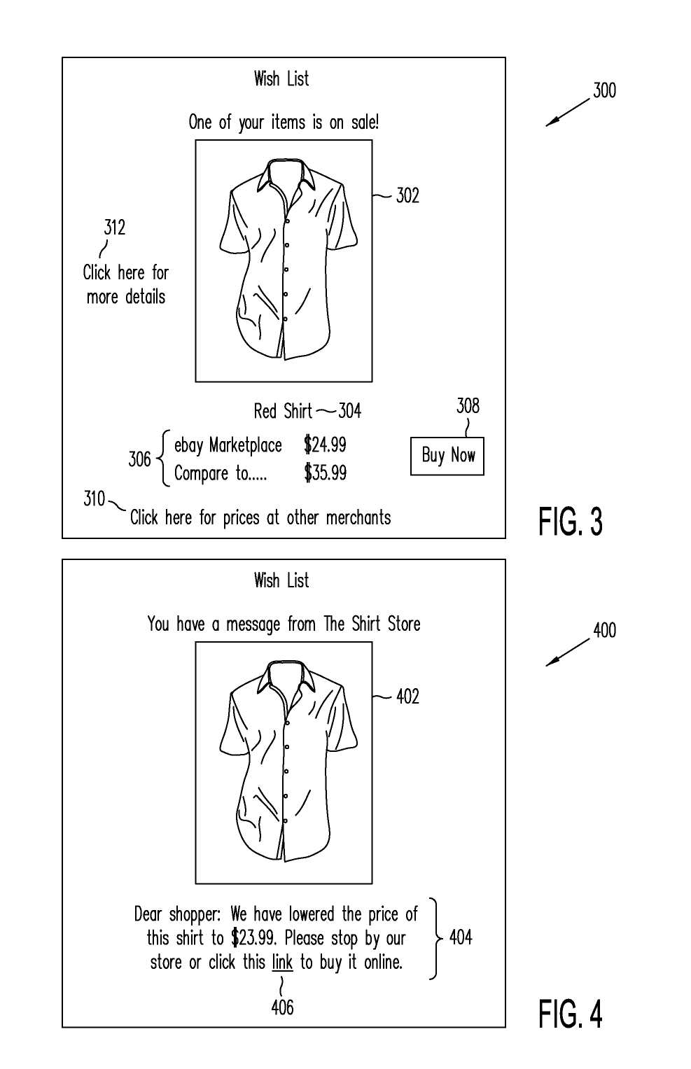

Interface 200 (as well as the interfaces of FIGS. 3-5) is accessible from any appropriate computing resource, not just a consumer's mobile device. Thus, in some embodiments, the information about the various physical shopping items is cached to an online resource and then becomes available on any device, provided the consumer logs into the resource. In one particular example, the consumer uses a mobile device while moving about the physical world to identify available physical shopping items, and the app or other computing resource uses online resources to make the information accessible to the consumer from any Internet-connected device. For instance, the consumer may access the information from a web browser, using the consumer's account, once the data has been uploaded to an online resource.

Continuing with the present example, the app or other computing resource checks various online catalogs for the same or similar items to go on sale or otherwise change price. Thus, the consumer may cache the information from the red shirt of FIG. 1, and the app or other computing resource then periodically checks online catalogs for sales of the red shirt. The sale information may then be presented to the consumer in any appropriate manner, such as in an email, a text message, pushed or pulled to the app, and/or the like.

FIG. 3 is an illustration of example interface 300 for viewing the consumer's wishlist, according to one embodiment. More specifically, interface 300 presents a price update to the consumer for the identified physical shopping item (in this example, the red shirt). Interface 300 includes thumbnail 302, a brief description of the item 304, and a description of the sale 306 with a price comparison to the original price. Interface 300 further includes link 310 to show on the same or different screen comparisons to other merchants and link 312 to expand details about the item.

In the example of FIG. 3, the app or other computing resource has found a sale on the red shirt from an online merchant for ten dollars less than the original price. The notification 306 may include a link for more information. If the consumer is interested in purchasing the item from the indicated online retailer, the consumer may use button 308, which takes the consumer to a shopping cart provided by the online merchant. The sale message may include any appropriate information, such as information about a general sale as well (e.g., the shirt is available for a special weekend sale where buyers buy one and get the second item for 50% off). In short, interface 300 allows a consumer to be up-to-date on price moves for the item and allows the consumer to purchase the item, if available from a participating retailer.

However, the example embodiment is more than just another way to facilitate online shopping in favor of online merchants. As mentioned above, participating brick and mortar merchants may be informed of the consumer's interest in the item, and in some embodiments, participating merchants may be kept informed of price moves that are presented to the interested consumer.

Whether the brick and mortar merchant is motivated by the presentation of the online deal to the interested consumer, or whether the brick and mortar merchant is motivated by some other factor, the brick and mortar merchant can use the online resource of the embodiment to send a message to the consumer pertaining to the identified item. In order to make the sale, the brick and mortar merchant may change the offer to entice the consumer back into the store. For instance, the brick and mortar merchant may offer an additional good or service or may change the price of the identified item and then send a message to the consumer regarding the offer.

FIG. 4 is an illustration of example interface 400 for the consumer to view messages from a merchant, according to one embodiment. Interface 400 includes thumbnail image 402 and message 404. In this example, the merchant from the brick and mortar store, from which the consumer identified the red short, has sent a message 404 to the consumer offering the identified shirt for eleven dollars off the original price.

In some instances, a brick and mortar merchant may also provide for online purchases from the merchant. Thus, in this example, the merchant has also included a link 406 to allow the user to purchase the shirt from the merchant, should the consumer prefer to buy online rather than make another trip to the physical store.

The present embodiment provides an advantage to participating brick and mortar stores by informing them of interest in their goods and allowing them to communicate with interested consumers. Participating merchants may access the described functionality from an app and/or from another computing resource (e.g., over the Internet using a web browser).

The described embodiments are not limited to identifying items from participating merchants or identifying items that are also available online. The consumer can identify any appropriate item at any physical store in the world. In a scenario wherein the item is not available online, the consumer may have to populate the fields of FIG. 1 manually to fully identify the item. In a scenario wherein the merchant is not a participating merchant, the merchant may not receive information indicating interest in the item and/or may not be able to send messages to the consumer through interface 400. However, the merchant receives an advantage by participating, and the consumer receives increased functionality by being able to receive updates from a participating merchant.

Links 308 (FIG. 3) and 406 allow the consumer to participate in an online transaction with a merchant. Various embodiments may include other screens (not shown) for the consumer, such as a screen wherein the consumer views a shopping cart and has a chance to confirm the transaction, edit the transaction, or cancel the transaction. Any appropriate form of payment now known or later developed can be used in the various embodiments.

The example embodiment described thus far also offers an alternative to periodic merchant emails. It is conventional that consumers may indicate to a number of merchants that they would like to receive promotional messages. However, consumers may later feel regret when their email inboxes fill with emails from those merchants because numerous emails may make it difficult to identify important messages and may drown out interesting offers.

The example embodiment aggregates offers from merchants, whether participating or not, and allows the consumer to view the offers in a convenient interface at a convenient time. For instance, participating merchants may send their offers to an online resource which matches those merchants to consumers who have identified an interest in those merchants in the past. Additionally, the online resource may also scour online catalogs for offers on goods the same as, or similar to, items identified by respective consumers. The online resource, for each participating consumer, then aggregates appropriate offers and presents them in a convenient interface.

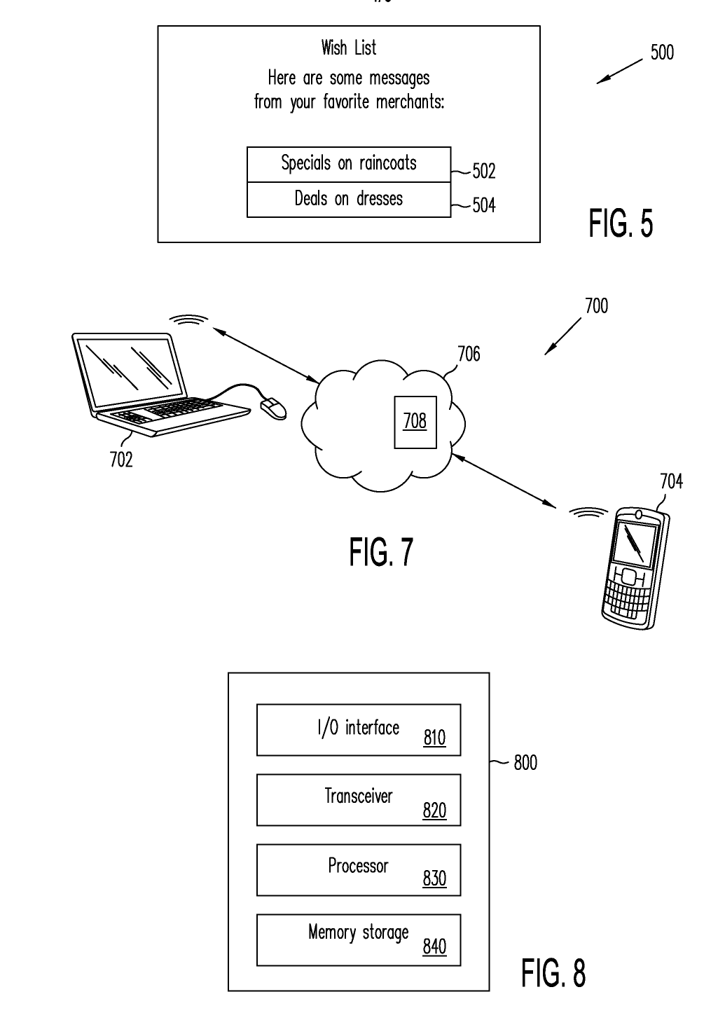

FIG. 5 is an illustration of an example interface 500, adapted according to one embodiment. Interface 500 includes aggregated messages 502, 504 and/or offers that are appropriate for the consumer. In this example, the consumer may indicate an interest in a merchant by identifying the merchant and/or identifying items offered by the merchant. Also, the online resource may select offers from online catalogs that are assumed to be for items that the consumer would be interested in based on previous activity by the consumer.

Messages 502, 504 may be presented to the consumer in any appropriate manner, such as in a compact form, as shown in FIG. 5. The consumer may select a message, and the message is expanded (not shown) for viewing. Such messages may take the place of promotional emails and, because they are aggregated and presented at a time of the consumer's choosing in a convenient interface, may be more desirable than promotional emails.

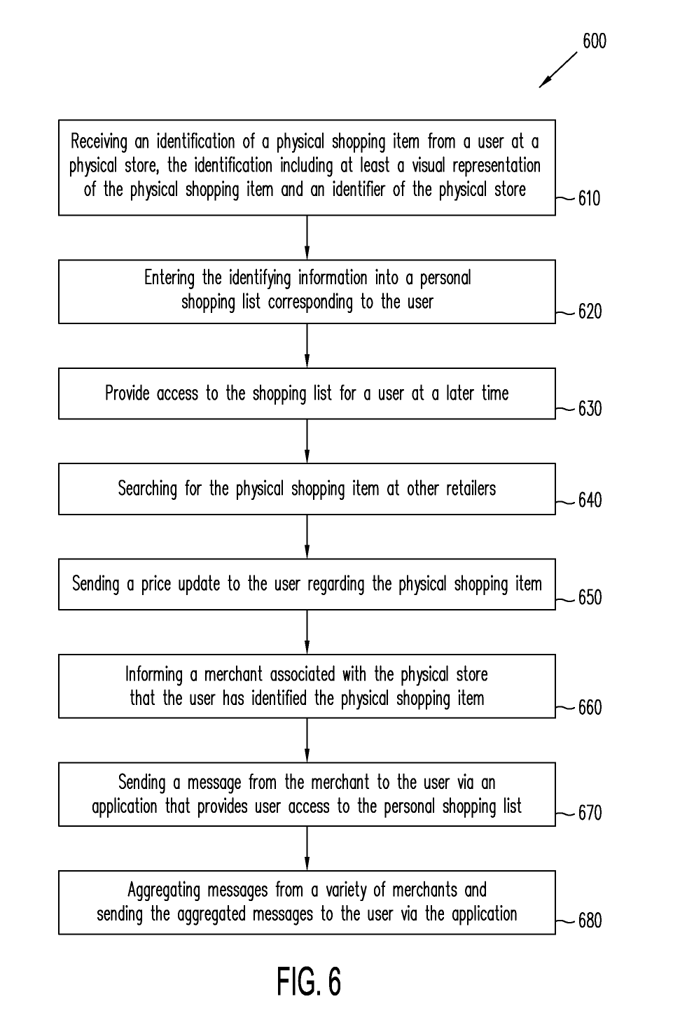

FIG. 6 is an illustration of method 600, adapted according to one embodiment, to cache information about physical shopping items. The actions of FIG. 6 may be performed by an application, browser, or other utility of the consumer and/or by online computing and storage resources of a provider of the caching service (such as an entity that provides the app to the consumer). In some embodiments, the various actions are carried out by one or more computer processors executing computer code to provide the described functionality.

In action 610, the computing resource receives an identification of a physical shopping item from a user at a physical store. The identification includes at least a visual representation of the physical shopping item and an identifier of the physical store.

In one particular example, the user employs a camera on a handheld communication device to record an image of a bar code or QR code of an item at a brick and mortar location. The code is then used to access a visual representation of the item from an online database (e.g., an online catalog). In another example, the user employs a camera on the mobile device to take a picture of the item, and the computing resource may or may not use image matching to identify a same or similar item from online.

The physical store may be identified manually by the user. In another example, the application on the user's mobile device is “smart” enough to detect the store where the user is located, for example by GPS signals, or technologies inside the store such as its Wi-Fi network or Radio Frequency Identification (RFID) devices installed at the store, or by one or more pictures of the store, or directly from the QR code.

In action 620, the computing resource enters the identifying information into a personal shopping list that corresponds to the user. For instance, the information may be cached locally at a user's mobile device and/or online at a cloud-based resource. The shopping list is personal to the user. An example visual representation of a personal shopping list is shown in FIG. 2.

In action 630, the computing resource provides access to the shopping list for the user at a later time. For instance, the user may accumulate items in the personal shopping list and then view the shopping list at a more convenient time and place. Access to the shopping list may be provided to the user at a mobile device of the user or any other network-connectable device that can access online resources caching the information.

In action 640, the computing resources search for the same, or similar, physical shopping item at other retailers. Examples include searching for the item when the item's information is textual and/or making image matches from online databases.

In action 650, the computing resources send a price update to the user regarding the physical shopping item. For instance, if the physical shopping item, or an item similar thereto, goes on sale the computing resources inform the user in any appropriate manner. For instance, the user may receive an email, a text message, or see the update in an app or in a web interface. An example of a price update is shown in FIG. 3.

In action 660, the computing resources inform a merchant associated with the physical store that the user has identified the physical shopping item. For instance, the merchant may be a participating merchant who receives such information regularly from the computing resources. The merchant may use the information in any way, including sending a message to the user to encourage the user to purchase the item, as in action 670. An example of a message from a merchant to the user is shown in FIG. 4.

In action 680, the computing resources aggregate messages from a variety of merchants and present the messages to the user. For instance, the computing resources may gather information about deals from a multitude of merchants and provide information about the deals in a convenient interface. An example of aggregated messages from a variety of merchants is shown in FIG. 5.

The scope of embodiments is not limited to the particular flow shown in FIG. 6. Rather, other embodiments may add, omit, rearrange, or modify one or more actions in accordance with a given design. For instance, some embodiments may omit the functionality to send messages from the merchant to the user and to aggregate messages, thereby functioning as a shopping list without contact to third parties. Other embodiments may add features, such as integration with electronic payment methods and the like.

FIG. 7 is an illustration of an example computer system 700, adapted according to one embodiment. Computer system 700 includes mobile device 704 and personal computer 702, both connected to a computer network 706 (e.g., the Internet). In one example, the consumer has mobile device 704, which runs software to provide an app with the functionality described above with respect to FIGS. 1-5.

Mobile device 704 is in communication with cloud-based resources 708, which may include one or more computers, such as server computers, with adequate memory resources to handle requests from a variety of users. A given embodiment may divide up the functionality (described above in FIG. 6) between mobile device 704 and resources 708 in any appropriate manner. For example, the app on mobile device 704 may take pictures and/or scan codes, but the majority of the processing and caching may be performed by resources 708. However, other divisions of responsibility are also possible in various embodiments.

Computer system 700 also includes personal computer 702 in communication with cloud based resources 708. In one example, a participating merchant may access information from the cloud-based resources 708 by logging on to a merchant account at computer 702. The various components of computer system 700 are shown as examples only. For instance, a given user may access the resources 708 by a number of devices, not all of the devices being mobile devices. Similarly, a merchant may access resources 708 from a number of mobile, non-mobile devices. Furthermore, resources 708 may accommodate many merchants and users in various embodiments.

FIG. 8 is a simplified block diagram of an example electronic device 800 on which the application (accessed by the consumer) may be implemented according to various aspects of the present disclosure. The electronic device 800 may be a portable personal electronic device, such as a smart phone, laptop, or a tablet. The electronic device 800 includes an input/output interface 810. The interface 810 is operable to receive an input from a user and communicate an output to the user. The user may include a consumer or a merchant. In an embodiment, the input/output interface 810 includes a visual display unit, for example a touch-sensitive screen. Input/output interface 101 may display a graphical interface, such as interfaces 100 through 500 of FIGS. 1-5.

The electronic device 800 includes a transceiver 820. The transceiver 820 is operable to electronically communicate with external devices. In an embodiment, the transceiver 820 is operable to wirelessly communicate with cellular towers or other network access points and infrastructure. The electronic device 800 also includes a computer processor 830 that is operable to execute computer instructions and a memory storage 840 that is operable to store the computer instructions.

The memory storage 840 also contains a program module that is an embodiment of the application that interacts with the consumer and/or the merchant. The program module operates to provide actions, such as facilitating item identification, interacting with the user, providing payment, and/or the like.

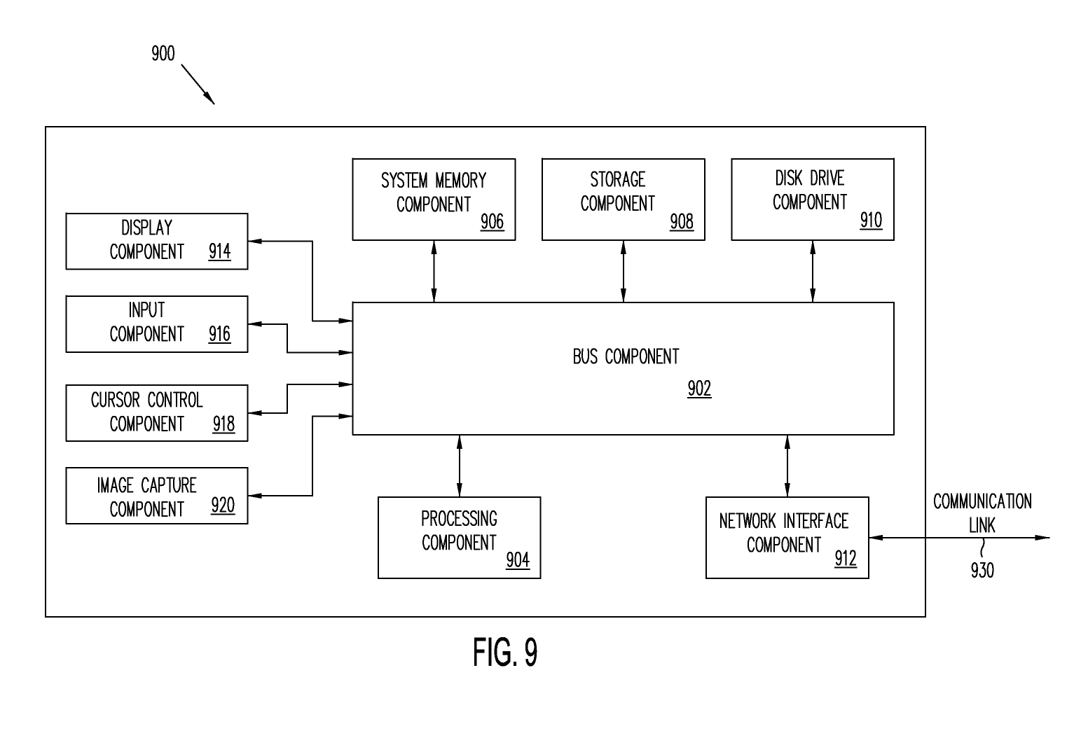

FIG. 9 is a block diagram of a computer system 900 suitable for implementing various methods and devices described herein, for example, the various method blocks of the method 600. For example, the computer system 900 may represent a computer upon which the consumer sees interfaces 100 through 500. In another example, the computer system 900 may represent a server computer or other type of computer that can be used as part of an e-commerce infrastructure at the merchant or at a party that provides the shopping list functionality. Accordingly, it should be appreciated that each of the devices may be implemented as the computer system 900 for communication with a network in a manner as follows.

In accordance with various embodiments of the present disclosure, the computer system 900, such as a mobile communications device and/or a network server, includes a bus component 902 or other communication mechanisms for communicating information, which interconnects subsystems and components, such as processing component 904 (e.g., processor, micro-controller, digital signal processor (DSP), etc.), system memory component 906 (e.g., RAM), static storage component 908 (e.g., ROM), disk drive component 910 (e.g., magnetic or optical), network interface component 912 (e.g., modem or Ethernet card), display component 914 (e.g., touch-screens, cathode ray tube (CRT) displays, or liquid crystal display (LCD)), input component 916 (e.g., keyboard or touch-sensitive components operable to detect a touch by a human body), cursor control component 918 (e.g., mouse or trackball), and image capture component 920 (e.g., analog or digital camera).

In one implementation, disk drive component 910 may comprise a database having one or more disk drive components.

In accordance with embodiments of the present disclosure, computer system 900 performs specific operations by processor 904 executing one or more sequences of one or more instructions contained in system memory component 906. Such instructions may be read into system memory component 906 from another computer readable medium, such as static storage component 908 or disk drive component 910. In other embodiments, hard-wired circuitry may be used in place of (or in combination with) software instructions to implement the present disclosure.

Logic may be encoded in a computer readable, non-transitory medium, which may refer to any medium that participates in providing instructions to processor 904 for execution. Such a medium may take many forms, including but not limited to, non-volatile media and volatile media. In various implementations, non-volatile media includes optical or magnetic disks, such as disk drive component 910, and volatile media includes dynamic memory, such as system memory component 906.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 930 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 900 may transmit and receive messages, data, information and instructions, including one or more programs (i.e., application code) through communication link 930 and communication interface 912. Received program code may be executed by processor 904 as received and/or stored in disk drive component 910 or some other storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic system comprising:
an input/output interface operable to receive an input from a user and communicate an output to the user;
a transceiver operable to electronically communicate with a computer network;
a computer processor operable to execute instructions; and
a memory storage operable to store the instructions, the memory storage further comprising a program module that is operable to:
receive identifying information of a physical shopping item while at a physical shopping location selling the physical shopping item, the identifying information including at least an identifier of the physical shopping location and a visual depiction of the physical shopping item;
cache the identifying information in a shopping list with a plurality of other physical shopping items associated with the user; and
provide access to the shopping list for the user at a later time.

2. The electronic system of claim 1, wherein the program module is further operable to identify similar shopping items by accessing online resources.

3. The electronic system of claim 1, wherein the program module is further operable to access online resources to identify when the physical shopping item, or a similar shopping item, changes price.

4. The electronic system of claim 1, wherein the program module is further operable to access online resources to receive updates from a merchant at the physical shopping location.

5. The electronic system of claim 1, wherein caching the identifying information comprises at least one of saving the identifying information to a memory of the electronic system and saving the identifying information to an online memory.

6. The electronic system of claim 1, wherein saving the identifying information for an online memory comprises saving the identifying information to an online system that shares the identifying information with a merchant at the physical shopping location.

7. The electronic system of claim 1, wherein the identifying information includes at least one of a visual image of the physical shopping item and a code associated with the physical shopping item.

8. The electronic system of claim 1, wherein receiving identifying information includes at least one of using a positioning location system to determine an approximate location of the physical shopping location.

9. The electronic system of claim 1, wherein the electronic device comprises at least one of a laptop computer, a tablet computer, and a phone.

10. A method comprising:
receiving, electronically by a processor of a service provider, an identification of a physical shopping item from a user at a physical store, the identification including at least a visual representation of the physical shopping item and an identifier of the physical store;
entering, electronically by the processor, the identifying information into a personal shopping list corresponding to the user, where the shopping list is accessible at a later time of the user's choosing;
searching, electronically by the processor, for the physical shopping item at other retailers; and
sending, electronically by the processor, a price update to a user device regarding the physical shopping item.

11. The method of claim 10, wherein receiving an identification comprises at least one of receiving a digital photograph of the physical shopping item and receiving scanned code information associated with the physical shopping item.

12. The method of claim 10, further comprising:
informing a merchant associated with the physical store that the user has identified the physical shopping item, in which the price update is received from the merchant.

13. The method of claim 12, further comprising:
sending a message from the merchant to the user via an application that provides user access to the personal shopping list.

14. The method of claim 10, further comprising providing the user with access to the personal shopping list at the later time.

15. The method of claim 14, wherein access to the personal shopping list is provided via an application on a mobile device, the method further comprising:
aggregating messages from the merchant and other merchants; and
sending the aggregated messages to the user via the application.

16. The method of claim 14, wherein access to the personal shopping list is provided via an application on a mobile device, the method further comprising:
receiving positioning system data from the mobile device to identify the location of the physical store.

17. The method of claim 10, wherein searching for the physical shopping item comprises:
matching a digital photograph of the physical shopping item to visual representations of similar goods.

18. A computer program product having a computer readable medium tangibly recording computer program logic for facilitating shopping, the computer program product comprising:
code to receive input from a user at a mobile device, the input identifying a physical shopping item at a physical store at which the user is located;
code to enter a description of the physical shopping item, including a visual depiction of the physical shopping item and an identifier of the physical store into a personal shopping list for the user, where the personal shopping list is available to the user at a later time of the user's choosing; and
code to search online for the physical shopping item and to return results of the search to the user; and
code to provide price updates for the physical shopping item to the user.

19. The computer program product of claim 18, further including:
code to inform a retailer of the physical store about the input identifying the physical shopping item; and
code to convey a message from the retailer to the user via an application on the mobile device.

20. The computer program product of claim 18, further comprising:
code to aggregate messages from the retailer and other retailers and to present the aggregated messages via an application on the mobile device.
